(19) United States
(12) Patent Application Publication
(10) Pub. No.: US 2006/0234079 A1
(43) Pub. Date: Oct. 19, 2006

(54) Smart-cut of a thin foil of poruous Ni from a Si wafer

(75) Inventors: Xi Zhang, Los Angeles, CA (US); King-Ning Tu, Los Angeles, CA (US)

Correspondence Address: DLA PIPER RUDNICK GRAY CARY US, LLP, 4365 EXECUTIVE DRIVE, SUITE 1100, SAN DIEGO, CA, 92121-2133, US

(73) Assignee: University of California, Los Angeles, Los Angeles, CA (US)

(21) Appl. No.: 11/395,394

(22) Filed: Mar. 30, 2006

Related U.S. Application Data
(60) Provisional application No. 60/667,189, filed on Mar. 30, 2005.

(51) Int. Cl. B05D 1/18; B05D 3/00; B05D 1/32; B21C 37/00

(52) U.S. Cl. 428/606; 427/299; 427/437; 427/430.1; 427/282

(57) ABSTRACT

The present invention is a method of fabricating a self-peeling nickel foil from a silicon wafer. The method includes forming a template of silicon by electrochemically etching a portion of the Si wafer to create a porous Si portion with pores of a desired depth. Then electrolessly plating nickel into the template, wherein the porous silicon portion is converted into a porous nickel portion and continuing the electroless plating until the internal tensile stress at an interface of the porous nickel portion and the silicon wafer is great enough to self-peel the porous nickel portion from the silicon wafer creating a nickel foil.

### CROSS REFERENCE TO RELATED APPLICATIONS

This application relies for priority under 35 U.S.C. §119(e) on U.S. provisional application No. 60/667,189, filed Mar. 30, 2005, the content of which is incorporated herein by reference in its entirety.

### STATEMENT OF GOVERNMENT SUPPORT

This invention was made in part with government support under Grant No. ECS-0120368 awarded by the National Science Foundation. The United States government may have certain rights in this invention.

### BACKGROUND OF THE INVENTION

1. Field of the Invention

The present invention relates generally to fabrication of nickel foil, and in particular, to single step fabrication of nickel foil that is smart-cut (or self-peel) from electrochemically etched porous silicon.

2. Background Information

Porous metals are known to contain large internal surface areas, which if accessible, can be used in numerous applications, such as catalysis, batteries, fuel cells, capacitors, sensors and so on. Metals with well-ordered porous networks would exhibit photonic properties, with potential for photonic crystal and optical applications. Porous structured metals may also have important technological applications in electronics and optoelectronics.

Template-directed synthesis, based on template chemistry, has been recently adapted to the fabrication of both meso- and macroporous metals with highly large and accessible area of metallic surfaces. Templates used in the fabrication processes include liquid-crystalline surfactant assemblies and anodically etched alumina membranes, bringing about mesoporous metals which are typically with cylindrical voids. More lately, macroporous metals with pore size larger than 100 nm have been fabricated by using colloidal crystallites as templates, resulting in 3-dimensionally stacked and interconnected spherical voids in the solid matrix. So far each of the approaches has been reported to comprise more than two steps.

Accordingly, there remains a need for methods and compositions that provide a more straightforward and less costly way of making functional metals with embedded porous microstructures.

### SUMMARY OF THE INVENTION

The present invention discloses an aqueous method of fabricating metallic macroporous nickel foils out of silicon-based macroporous silicon that is used as the template. By immersion of the macroporous silicon in a prepared nickel bath, the replication was achieved through whole nickel displacement over the silicon pore sidewalls, while the original macroporous structure was maintained. Once fabricated, the as-formed porous nickel foil with high-aspect-ratio macropores are able to smart-cut (or self-peel) from the non-porous silicon base.

### BRIEF DESCRIPTION OF THE DRAWINGS

FIG. 1 shows a 2 cm×2 cm portion of a silicon wafer with a photo resist pattern exposing a 1 cm×1 cm center portion.

FIG. 2 is a sectional view taken at 2-2 of FIG. 1.

FIG. 3 shows the wafer of FIG. 1 after the replacive electroless plating process and the porous Ni portion.

FIGS. 4 and 5 are sectional views taken at 4-4 of FIG. 3.

FIG. 6 shows a scanning electron microscopic image of a porous Ni surface.

FIG. 7 shows FESEM and TEM (lower right) micrographs of the macro pores with high aspect ratio formed in p⁻ Si. Anodization was conducted in 8% HF DMSO solution with 8-mA/cm² current density applied in a two-electrode Teflon cell at room temperature.

FIG. 8 shows an X-ray diffraction pattern of a macroporous sample after 8-hour replication depicts.

FIG. 9 shows FESEM micrographs of a macroporous sample after 1-hour immersion in the Ni plating bath.
(a) is a low magnification of the cross section;
(b) is a magnified array of metallized pores;
(c) a typical Si pore at the level where no significant deposition occurred;
(d) a typical Ni pore that was metal plating modified

FIG. 10 shows FESEM micrographs of a macroporous nickel sample replicated out of the mother silicon template depicts where:
(A) is a top view of the HF-etched macroporous silicon;
(B) is a top view of the as-formed macroporous nickel and the pore array imaged (inset) after ion beam sputtering of top surface;
(C) is a low magnification cross-sectional image of the straight macropores; and
(D) is a highly magnified image of the morphology of two neighboring pores and separation sidewall.

FIG. 11 shows TEM micrographs of a macroporous nickel sample, where
(a) is a planar view of the nanocrystalline Ni sidewall (epoxy was used as support during polishing process in TEM sample preparation);
(b) shows a selected area for electron diffraction (SAED) with diffraction pattern; and
(c) is the diffraction pattern showing Ni FCC (111), (200), (220), (311), (222) etc and nanoscale grains.

FIG. 12 shows electron micrographs of the macropores at the bottom surface of the 200 μm thick macroporous nickel sheet, where:
(A) is a cross-sectional TEM micrograph of a straight Ni pore self-peeling upon complete replication
(B) is a SEM micrograph of the thick porous Ni foil self-peeling;
(C) is a SEM micrograph of the dome shaped bottom appearance of the Ni macropores; and
(D) is a SEM micrograph (from the rear) of the peeled Ni sheet with macropores showing the embedded nanoporosity.

### DETAILED DESCRIPTION OF THE INVENTION

The present invention discloses a processing method to produce micro porous nickel (Ni) foils from porous silicon (Si). The disclosed process can obtain a stand-alone Ni foil from the Si wafer without mechanical cutting or polishing, just by the electroless plating process.

The process starts with a Si wafer 100 of appropriate size and thickness, such as a 4-inch diameter wafer with a thickness of about 0.5 mm. The present invention is not limited in size. For example, if the disclosed method is started with a large size Si wafer, such as 6, 8, or 12 inches, it can produce very large porous Ni foils by the disclosed smart-cut method.

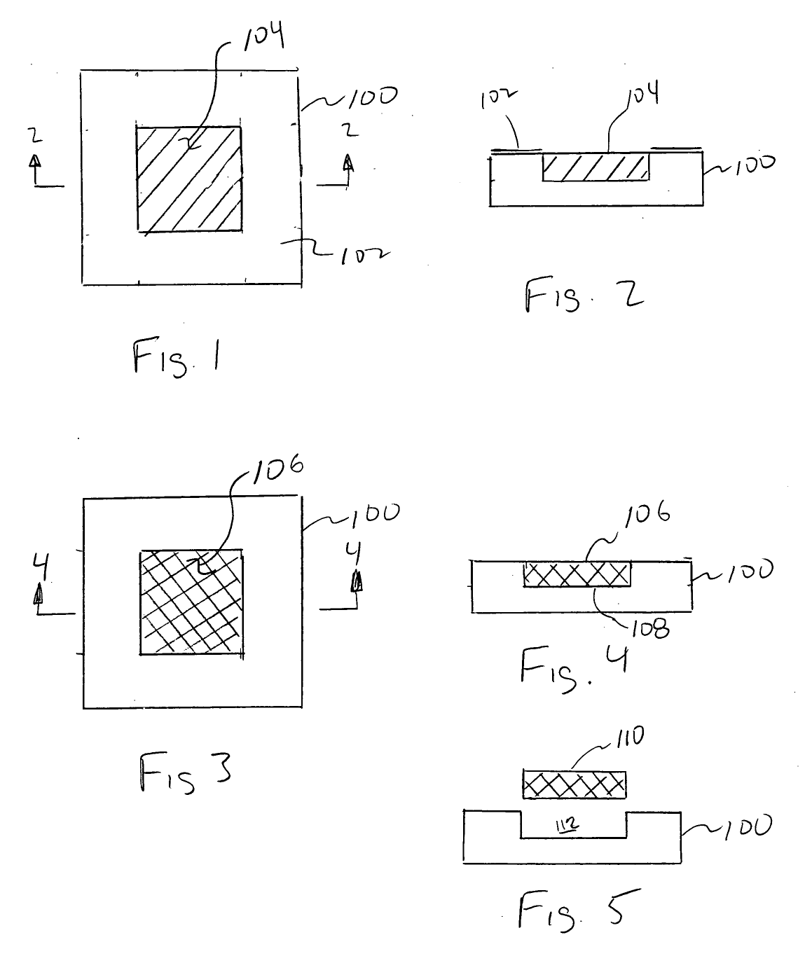

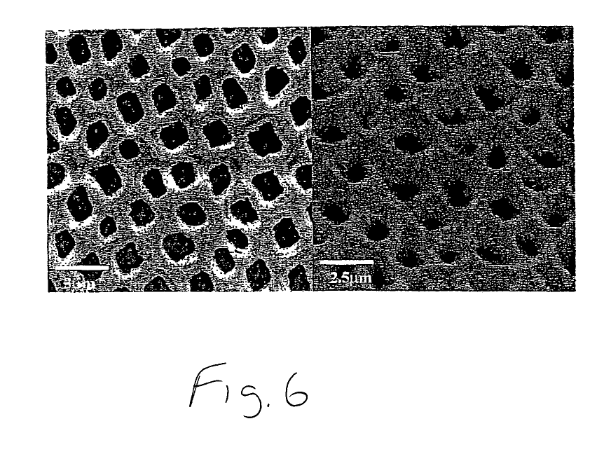

FIG. 1 depicts a 2 cm square piece or chip 100 of the Si wafer. A photo-resist pattern 102 is applied to the chip 100 surface leaving open an area of 1 cm square in the Si chip 100. Using an etching process, discussed below, a porous Si portion 104 is obtain with one-dimensional pores in the 1 cm square area of the Si chip 100, see FIGS. 1 and 2. The depth of the pores depends on the etching time. For example, an etching time of 12 hours may generate pores of about 200 microns in depth. The aspect ratio of the pores may about 100 to over 250.

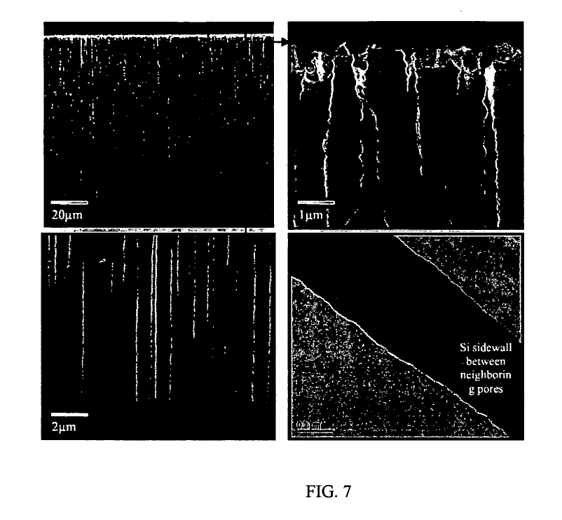

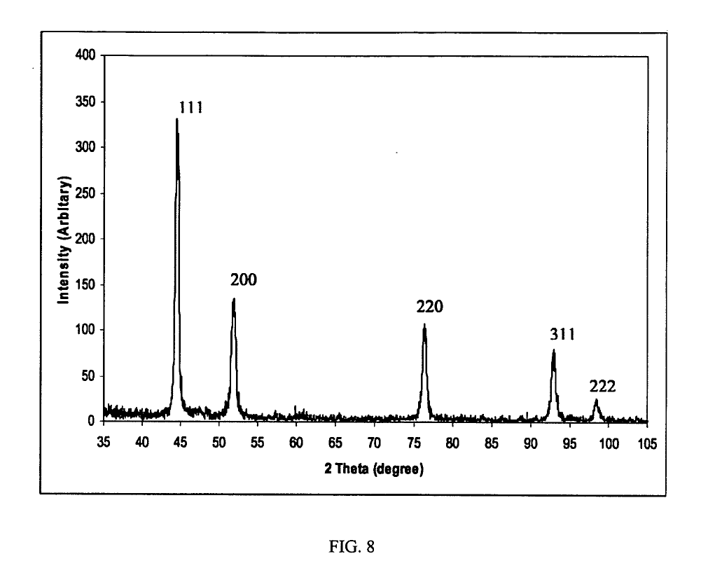

In the next step, a replacive electroless plating process is used to plate Ni into the pores in the porous Si portion 104. Since it is a replacive reaction, the plated Ni will convert the porous Si portion 104 into a porous Ni portion 106, see FIGS. 3 and 4.

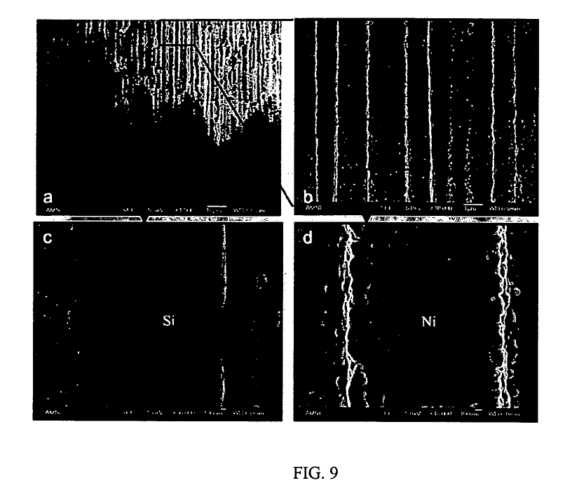

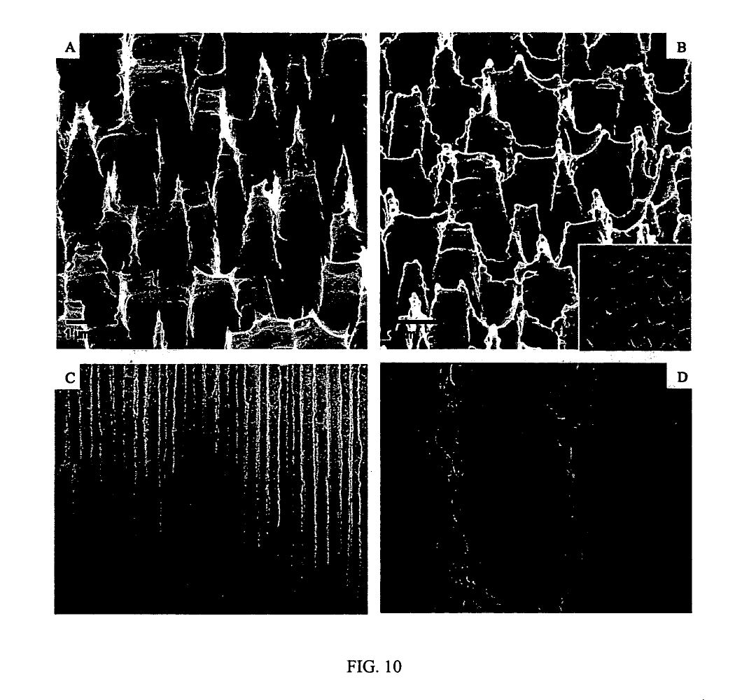

At the end of the replacive electroless plating process, the porous Si portion 104 is converted into a porous Ni portion 106. Due to the internal tensile stress at the interface 108 between the porous Ni portion 106 and the surrounding Si chip 100, the porous Ni portion 106 is broken automatically (i.e., smart-cut or self-peeling) from the Si chip 100 creating a Ni foil 110, or in other words, the present invention discloses a method of smart-cut of a thin foil 110 of porous Ni from a Si wafer 100, as shown in FIG. 5. The porous Ni foil 110 may be picked up by a magnet, and a 1 cm square dimple 112 is left in the center of the Si chip 100. To enhance the smart-cut by increasing the tensile stress between the porous Ni portion 106 and Si chip 100, the Si chip 100 and porous Ni portion 106 may be cooled to ice temperature or even lower temperature. FIG. 6 shows a scanning electron microscopic image of a porous Ni surface.

The Ni foils 110 may be used in many applications, such as biomedical materials, sensor materials, magnetic materials, and energy materials. In one embodiment, thermal annealing in a vacuum can densify the porous Ni slightly and improve greatly its mechanical strength. In another embodiment, titanium (Ti) films may be evaporated over the pores of the Ni portion to make the surface of the Ni foil to be bio-compatible so that hydroxyapetite can grow into the porous structure. The porous hydroxyaptite can be used to culture or to grow live cells. Due to the porous metallic core structure, it has much better mechanical strength then the conventional type of hydroxyapetite structure. Since the Ni foil is ductile, it can deform into many kinds of shapes before Ti deposition and hydroxyapetite growth. In another embodiment, after Ti deposition, the porous structure can be annealed to produce NiTi alloy, which has well known shape memory properties. The principle of smart-cut of porous metal foils disclosed herein should not be limited to Ni foils, as it can be modified to produce other porous metal foils.

The present invention is directed to porous nickel electrolessly plated via a single-step replication of the template. As used herein, the term “templating” refers to a technology that involves a prior formation of a temporary medium whose interstitial empty space is then filled with another material and a porous material is consequently formed via replication after the template removal by certain means. HF-etched macroporous silicon (Si) was chosen to be the starting template. Macropore formation in Si has been extensively researched in the last decade. It was found that the macropore formed in n-type Si is driven by photo-electro-chemical etching in HF, and surface pre-patterning is usually required. Macropore formation in p-type Si has also been well documented. Macropores formed in Si can be either orderly arrayed with pre-patterned etching pits or random on polished surface without using lithography. The morphology is determined during etching by a few parameters such as Si resistivity, current density, HF concentration, nature of solvent, treatment time etc. Pore sizes are controllable, ranging from 100 nm to several μm.

In subsequent process, electroless plating bath is employed for metal deposition. The formation of porous nickel is accomplished by immersion of the template in a prepared nickel sulfate bath, in which redox reactions occurred on the macropore sidewalls between the nickel ions of aqueous solution and the Si atoms of template skeleton. This templating scheme could be generic for all other metals whose ions are reduced through electron exchange with Si in open-circuit wet processes, including the noble metals like copper, gold, silver, and platinum.

In contrast to the two-step molding typically reported in earlier work, the present invention is able to replicate the template directly and produce arrays of high aspect ratio straight metal holes. The details will be discussed with assistance of scanning electron microscopy (SEM), transmission electron microscopy (TEM), and energy dispersive X-ray (EDX) as major characterization tools

The invention will now be described in greater detail by reference to the following non-limiting examples.

### EXAMPLE

The following is one example of the etching condition to create porous Si:
Chemical solution: 8% HF+8% H₂O+DMSO (total 100 ml in the three electrode cell);
External electrical source: galvanostatic 8 mA current density;
Three-electrode call: two platinum sheets plus a piece of Si wafer;
Ambient: room temperature, static conditions;
Etching duration: 12˜15 hours;
Material: 2 cm by 2 cm square piece cut from p− 4-inch Si wafer (10˜20 ohm-cm resistivity), thickness 400˜500 microns;
Window exposure to the etching solution: 1 cm by 1 cm;
Where the full name of DMSO is Methylsulfoxide and its formula weight is 78.17

Before the electroless plating, a pretreatment of porous Si is given as, APM (ammonium hydroxide, hydrogen peroxide, water mixture) at 70˜80° C. for 15 minutes followed by DI water rinsing for 2 minutes, and then dilute HF (5%) dipping for 3 minutes at room temperature followed by DI water rinsing for 2 minutes.

Replacive electroless plating is used to plate Ni into the pores in the porous Si. Since it is a replacive reaction, the plated Ni will convert the porous Si into porous Ni. The surface of the porous Ni has been shown in FIG. 6. One example of a replacive electroless process is given below:
Solution Composition:
Nickel Sulfate: 1M (mol/liter)
Ammonium Sulfate: 0.5M
Ammonium Fluoride: 2.5M
Sodium Lauryl Sulfate (wetting agent of surfactant): 10˜20 mg
DI water: for a final volume 50 ml of plating bath
Ammonium Hydroxide: for maintenance of the pH 7˜8 during the process
Plating ambient: temperature 60° C., static bath
Immersion durations: 8 hours or longer

Low doped p-type Si (100) wafer with resistivity ˜10 Ω-cm was chosen as the starting substrate material. Macropores can be formed in different processes as mentioned above. For simplicity, no pre-patterning work was employed to make etching pits as pore nucleation centers for a consequent formation of an ordered array of macropores with uniform inter-pore distance and pore diameter.

Polished (100) Si wafer surface was directly electrochemically etched in a mixture of HF (original 48% aqueous) and organic solvent DMSO (both are of analytical grade). Alternatively, a mixture of 8% HF, 8% H₂O and organic solvent 84% DMSO may be used. The Si wafer was pre-cut into 2 cm×2 cm pieces (such as shown in FIG. 1). A two electrode Teflon cell setup was used and a 1 cm×1 cm window exposure was opened in the photo resist on the Si surface that was in contact with the solution. Platinum served as the cathode and backside contact the electrode. Si anodization was carried out at a constant value current density of 8 mA/cm². The resultant macropores are arrayed with average diameter about 1 μm and the separation distance of each other is about 0.5 μm. Final aspect ratio is a function of etching time and it was >250 after approximate 12 hour treatment.

Freshly anodically etched Si with macropores thus served as the template for the following replication process of metallization work. Wet plating was conducted in a prepared electroless chemical bath containing a high concentration of NiSO₄ (1.0 M) in an aqueous alkaline state with NH₄F (2.5 M). The pH value was adjusted by ammonia to 8.0. The solution was buffered by (NH₄)₂SO₄ to maintain the pH value while a small amount of wetting agent provides the surface with good wetting ability during the plating. Instead of using a reducing agent, fluoride was added to promote electroless deposition. In addition, the complexing agent was excluded. Template used macroporous Si was immersed for a period of duration at elevated temperature around 60° C. Both pH and working temperature were carefully monitored and maintained during the replication process.

An X-ray diffractometer (XRD, Siemens D5005) was used to measure the XRD spectrum. The samples were examined by field emission scanning electron microscope (FESEM, JOEL JSM-6700F) and transmission electron microscope (TEM, FEI/Philips CM200 FEG), both equipped with energy dispersive X-ray spectrometers (EDX, Oxford Instruments Inc.). Typically, for TEM observation the samples were manually or mechanically polished and further thinned by ion miller to approximately 100 nm thick. Epoxy was applied to support the metallic porous structure during sample preparation. Furthermore, nitrogen adsorption measurements were performed on a surface area analyzer (Micromeritics ASAP 2020). Prior to the sorption measurements, the samples were degassed under a vacuum at 200° C. Surface areas were then calculated by the Brunauer-Emmett-Teller (BET) method.

Si Macropores Formed After Anodization

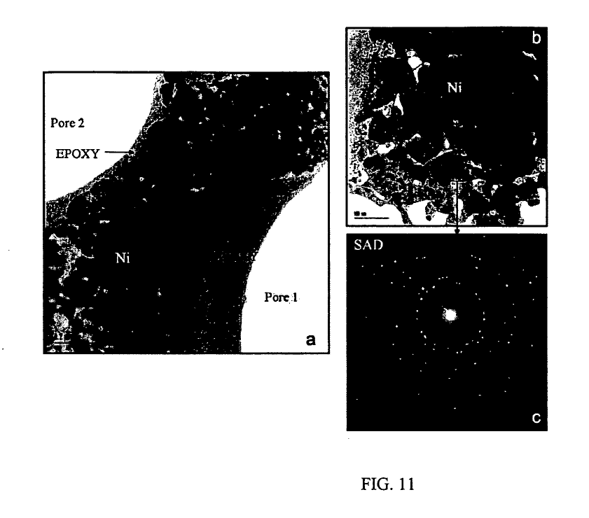

The macro pore etching is an anisotropic process and the resultant pore size was about 1 μm in this case. The mechanism of such electrochemical anodization of p⁻ Si is known in the literature and will not be elaborated here. Basically, pores with high aspect ratio can be formed, providing space accessible for the plating bath in the subsequent immersion process, and thus, the one-step replication of the Si pore sidewalls. SEM and TEM micrographs are displayed to show the deep macroporous structure in p⁻ Si, shown in FIG. 7

Metallic Porous Structure After Electroless Ni Plating

Electroless plating can be usually categorized into two major types, autocatalytic and displacement depositions, in which the common feature is that both are composed of two half-cell reactions or two redox couples. In fluoride contained alkaline media without reducing agent, the electron exchange is accomplished in general between the Si atoms at surface and Ni ions in the solution. In other words, the Ni deposition is at the expense of Si dissolution, a process called displacement. The driving force comes thermodynamically from the difference of electrode redox potentials, simply represented by the following equations.
SiF₆²⁻(aq)+4e⁻→Si⁰+6F⁻(aq) E⁰=−1.20 V (SHE) (1)
Ni²⁺+2e⁻→Ni E⁰=−0.257 V (SHE) (2)

Where E⁰ is the standard electrode potential referred to the standard hydrogen electrode.

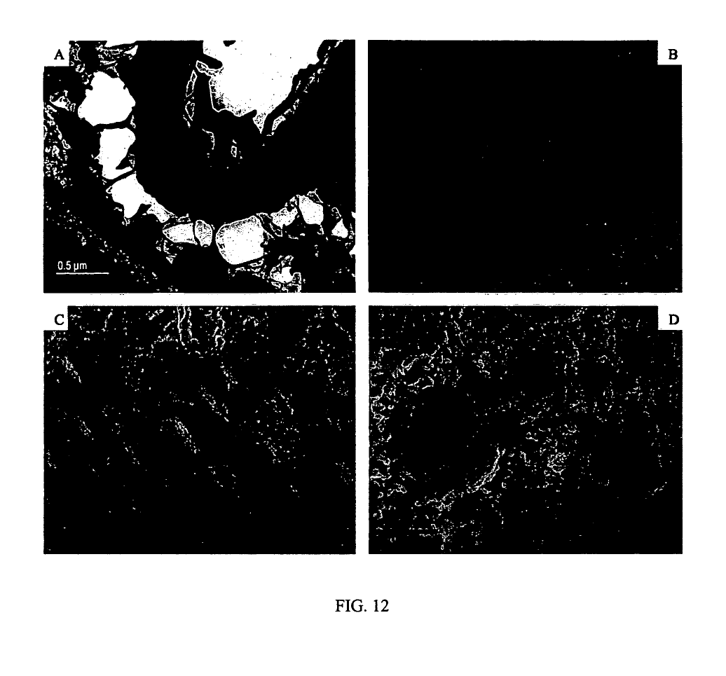

It's thus a favorable process of charge transfer from Si electrode to the Ni electrode. In the fluoride-containing Ni solution that was prepared, the Si was found to be gradually oxidized and eventually dissolved during the Ni deposition. One very significant observation was that reactions in the current process were able to proceed until a complete material change from Si to Ni, but the mother template structure was well inherited. Prolonged immersion of the macroporous Si layer of about 200 μm in thickness led to the formation of Si-free porous Ni layer of equal thickness. Using powder X-ray diffraction (PXRD), strong metallic Ni reflections were observed from an 8-hour electrolessly plated specimen, but no peaks of any residual crystalline Si phase were detected (see FIG. 8).

A group of Scanning electron micrographs (SEM) in FIG. 9 show differently magnified cross-sectional images of one sample immersed for 1 hour and surface morphologies at different depths for a Si pore almost intact and a Ni pore after consumption of Si. Micrograph a is a low magnification of the cross section, micrograph (b) is a magnified array of metallized pores, micrograph (c) is a typical Si pore at the level where no significant deposition occurred, and micrograph (d) is a typical Ni pore that was metal plating modified.

Another group of SEMs in FIG. 10 show images of a solid Ni matrix containing arrays of straight macropores after wet reaction, indicating a positive replica of the initial structure of macroporous Si. This striking similarity can be seen through the comparison of the SEM micrographs from a top view of the starting Si shown in SEM micrograph (A) of FIG. 10 and the resultant Ni shown in SEM micrograph (B) of FIG. 10. Chemical compositions of both of them were determined by energy dispersive X-ray spectra (EDX), confirming the total conversion from Si to Ni. By using focused ion beam etching, a typical planar section of the metallic macropore array is shown in the inset SEM micrograph (B) of FIG. 10. The cross-sectional image of the resultant Ni layer is shown in SEM micrograph (C) of FIG. 10. Here the morphological features of macropores are almost identical to those of the original Si template. In other words, the Ni foil with inlaid arrays of macropores is a true replication of the high-aspect-ratio macroporous Si. In view of the fact that both the pore size and the macroporous layer thickness of Si template can be controlled to a large degree, the example presented demonstrates the structural diversities by this simple approach for fabricating Ni foils with macroporous morphology. Furthermore as shown in micrograph (D) of FIG. 10, the as-formed Ni foil consists of fine features on the nanometer scale superimposed over the macroporous morphology. The nanoporosity of separation sidewall between neighboring macropores is a direct consequence of the Ni deposition process and does not exist in the macroporous Si structure. Given this structural feature, it would be reasonable to expect an enlarged internal surface area. By conducting the nitrogen adsorption analyses, results show that the measured BET surface area was increased from a value of about 5.16 (±0.13) m²/g to 11.35 (±0.23) m²/g, measured respectively for the macroporous Si template and the consequent Ni replica. Average nano-pore size is calculated (by BET) to be around 54.38 Å. Therefore as a result the existence of nano-scale pores in the Ni sidewalls may explain why the replication was progressed until all the skeleton Si has been consumed. Although displacement deposition is commonly known to be self-limiting when a complete layer of deposits is formed to separate the electrolyte from the underlying substrate, observation of nickel/silicon reaction process on sidewalls of the macroporous template is not as expected.

Selected area electron diffraction (SAED) analysis using a transmission electron microscope (TEM) reveals that the sidewalls are composed of Ni nano-crystallites of size less than 100 nm. In FIG. 11, planar TEM micrograph shows the domination of Ni as the material phase of sidewall after a proper way of replacement reaction. Selected area diffraction demonstrates the ring patterns corresponding to the Ni face-centered-cubic (FCC) (111), (200), (220), and (311) planes. The as-deposited grains appear to be on nanoscale with average size around a few tens of nanometers (<100 nm). The macro-nano-porous and nano-granular morphology of the Ni foil leads to much increased surface area and the hierarchical porous feature is considered a significant advantage for many chemical applications. Complete substitution of Si by Ni is highly interesting and results in a metallic structure with parallel and straight pores which may have wide applications. The easy process, low temperature, cheap materials, and simple experimental setup accredit this one-step replication approach.

Self-Peeling of the Porous Ni from Si Substrate

The present invention found that by extending the immersion time for further Ni displacement until the very end of pore depth, replication could go beyond the bottom end of straight macropores in the bulk Si underneath. Upon replicating a certain thickness in the non-porous Si base, a self-peeling of the as developed thick porous Ni foil is obtained with the macropore base closed by a Ni barrier layer, shown in FIG. 11. Micrograph (a) of FIG. 11 is a planar view of the nanocrystalline Ni sidewall (epoxy was used as support during polishing process in TEM sample preparation), micrograph (b) of FIG. 11 shows a selected area for electron diffraction (SAED) with diffraction pattern, and micrograph (c) of FIG. 11 is the diffraction pattern showing Ni FCC (111), (200), (220), (311), (222) etc and nanoscale grains.

In one example, a self-peeling of the as developed thick porous Ni foil at a dimension of 1 cm×1 cm×200 μm from Si was obtained. Such non-adherent nature of the as-deposited Ni layer over underlying Si base is likely due to the stress built in it during displacement deposition. Such a phenomenon that the layer of deposits comes off once it grows a certain thick was also found in the case of blanket Ni foil deposition on Si surface by means of the same wet chemistry. On the other hand, the silicide phase that usually bonds the metal layer and the Si substrate was however not detected.

Ni makes tough and sturdy free-standing porous foils. No obvious curling or fragment into smaller pieces was observed in the thick foils with high-aspect-ratio macropores. Electron micrographs in FIG. 12 show the dome-like appearance of the formed Ni macropores at the bottom surface of the 200 μm thick macroporous Ni sheet. Micrograph (A) of FIG. 12 is a cross-sectional TEM micrograph of a straight Ni pore self-peeling upon complete replication, micrograph (B) of FIG. 12 is a SEM micrograph of the thick porous Ni foil self-peeling, micrograph (C) of FIG. 12 is a SEM micrograph of the dome shaped bottom appearance of the Ni macropores, and micrograph (D) of FIG. 12 is a SEM micrograph (from the rear) of the peeled Ni sheet with macropores showing the embedded nanoporosity. Micrograph (D) of FIG. 12 also shows typically again the nanoporosity superimposed over the micron size pores from the rear of the Ni foil. In our discovery fresh Ni with hierarchical architecture (overall macroporous morphology with nanostructured skeletons) was template-generated by single-step replication and smart-cut from the underlying Si substrate by self-peeling.

In summary, a novel approach for fabricating free-standing macroporous Ni foils has been presented. The approach is based on a template of electrochemically etched macroporous Si. The Ni foil is formed as a replica of the macroporous Si skeleton. Si atoms are replaced by Ni atoms through immersion in the electroless Ni bath. Self-peeling is discovered after the full formation of the porous Ni foil. In addition to the macroporous morphology, the resultant Ni skeleton is punctuated with nanopores, making the surface area of the Ni foil much larger than that of the starting macroporous Si. This novel approach allows the fabrication of porous Ni foils, which are of considerable interest for working as electrodes and for many potential chemical applications.

Although the invention has been described with reference to the above examples, it will be understood that modifications and variations are encompassed within the spirit and scope of the invention. Accordingly, the invention is limited only by the following claims.

What is claimed is:

1. A method of fabricating a self-peeling nickel (Ni) foil from a silicon (Si) wafer, the method comprising:
forming a template by electrochemically etching a porous Si portion in the Si wafer creating pores of a desired diameter and depth;
electrolessly plating Ni into the template, wherein the porous Si portion is converted into a porous Ni portion; and
continuing the electroless plating until the internal tensile stress at an interface of the porous Ni portion and the Si wafer is great enough to self-peel the porous Ni portion from the Si wafer creating the Ni foil.

2. The method of claim 1, wherein the desired pore diameter is about 1 μm.

3. The method of claim 1, wherein the desired depth is about 200 μm.

4. The method of claim 1, wherein the electrochemically etching is done for a sufficient time to reach the desired depth of the pores.

5. The method of claim 4, wherein the time is about 12 hours.

6. The method of claim 1, wherein the pores have an aspect ratio between about 100 to 250.

7. The method of claim 1, wherein prior to electrochemically etching the method further comprises applying a photo-resist to a surface of the Si wafer with an opening the size of the desired porous Si portion.

8. The method of claim 7, wherein the opening size in the photo-resist is 1 cm×1 cm.

9. The method of claim 1, wherein continuing the electrolessly plating includes cooling the porous Ni portion and the Si wafer to enhance the tensile stress between them.

10. The method of claim 1, further comprising picking up the Ni foil with a magnet.

11. The method of claim 1, wherein electrolessly plating includes immersion of the porous Si portion in a nickel sulfate bath.

12. The method of claim 1, wherein etching of the Si wafer is done with a chemical solution of 8% HF+8% H₂O+DMSO.

13. The method of claim 1, wherein prior to electrolessly plating the method further comprises pretreating the porous Si portion with APM (ammonium hydroxide, hydrogen peroxide, water mixture) at 70 to 80° C. for 15 minutes followed by DI water rinsing for 2 minutes, and then dilute HF (5%) dipping for 3 minutes at room temperature followed by DI water rinsing for 2 minutes.

14. The method of claim 1, wherein the Si wafer has a resistively between 10 to 20 ohm-cm.

15. A method of fabricating a self-peeling nickel (Ni) foil from a silicon (Si) wafer, the method comprising:
applying a photo-resist to a surface of the Si wafer leaving an opening;
forming a template by electrochemically etching a porous Si portion in the opening creating pores of a desired diameter and depth;
pretreating the porous Si portion with APM (ammonium hydroxide, hydrogen peroxide, water mixture) at 70 to 80° C. for 15 minutes followed by DI water rinsing for 2 minutes, and then dilute HF (5%) dipping for 3 minutes at room temperature followed by DI water rinsing for 2 minutes;
electrolessly plating Ni into the template, wherein the porous Si portion is converted into a porous Ni portion; and
continuing the electroless plating until the internal tensile stress at an interface of the porous Ni portion and the Si wafer is great enough to self-peel the porous Ni portion from the Si wafer creating the Ni foil.

16. The method of claim 15, wherein continuing the electrolessly plating includes cooling the porous Ni portion and the Si wafer to enhance the tensile stress between them.

17. The method of claim 15, wherein the desired pore diameter is about 1 μm.

18. The method of claim 15, wherein the desired depth is about 200 μm.

19. The method of claim 15, wherein the electrochemically etching is done for a sufficient time to reach the desired depth of the pores.

20. The method of claim 19, wherein the time is about 12 hours.

21. A nickel (Ni) foil prepared by a process comprising the steps of:
(a) providing a silicon (Si) wafer with an exposed portion;
(b) etching the exposed portion of the Si wafer for a first period of time with a chemical solution of HF, H₂O and DMSO having adequate current density to form a porous Si portion on the Si wafer having macropores with an average diameter about 1 μm and a separation distance of each other of about 0.5 μm;
(c) electrolessly plating the porous Si portion in a chemical bath containing NiSO₄, NH₄F, and (NH₄)₂SO₄ for a second time period, wherein the porous Si portion is converted into a porous Ni foil; and
(d) separating the Ni foil from the Si wafer.

22. The nickel (Ni) foil of claim 21, wherein the Si wafer is a low doped p-type Si wafer with resistivity of 10 to 20 ohm-cm.

23. The nickel (Ni) foil of claim 21, wherein the first time period is 12 to 15 hours.

24. The nickel (Ni) foil of claim 21, wherein the concentration of the etching chemical solution is 8% HF, 8% H₂O and 84% DMSO.

25. The nickel (Ni) foil of claim 21, wherein the current density is 8 mA/cm².

26. The nickel (Ni) foil of claim 21, wherein the chemical bath includes 1M of NiSO₄, 2.5 M of NH₄F, and 0.5 M of (NH₄)₂SO₄.

27. The nickel (Ni) foil of claim 21, wherein a pH value of the chemical bath is maintained between 7 and 8 during the process.

28. The nickel (Ni) foil of claim 21, wherein the second time period is 8 or more hours.

29. The nickel (Ni) foil of claim 21, wherein electrolessly plating is done at a temperature around 60° C.

30. The nickel (Ni) foil of claim 21, wherein the porous Si portion has an average depth of 200 μm.

31. The nickel (Ni) foil of claim 30, wherein separating the Ni foil from the Si wafer occurs once the electrolessly plating extends beyond the 200 μm depth.

32. The nickel (Ni) foil of claim 21, wherein the exposed portion is an opening in a photo-resist on a surface of the Si wafer.

33. The nickel (Ni) foil of claim 32, wherein the exposed portion opening size in the photo-resist is 1 cm×1 cm.

34. The nickel (Ni) foil of claim 21, wherein electrolessly plating includes cooling the porous Ni foil and the Si wafer to enhance tensile stress between them.

35. The nickel (Ni) foil of claim 21, wherein prior to electrolessly plating the process further comprises pretreating the porous Si portion with APM (ammonium hydroxide, hydrogen peroxide, water mixture) at 70 to 80° C. for 15 minutes followed by DI water rinsing for 2 minutes, and then dilute HF (5%) dipping for 3 minutes at room temperature followed by DI water rinsing for 2 minutes.
